(19) United States
(12) Patent Application Publication
(10) Pub. No.: US 2004/0225525 A1
(43) Pub. Date: Nov. 11, 2004

(54) Automatic contacts replication system and software

(76) Inventor: Vernon L. Weitzman, Los Gatos, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/839,649

(22) Filed: May 4, 2004

Related U.S. Application Data
(60) Provisional application No. 60/468,343, filed on May 5, 2003.
(60) Provisional application No. 60/470,830, filed on May 14, 2003.

(51) Int. Cl. G06F 17/60

(52) U.S. Cl. 705/1

(57) ABSTRACT

A software program (18) is disclosed for periodically collecting and distributing updated information to a number of personal devices (22), to be used with a central server (12) having a database (14), and a data network (11) including at least one server (26), where each personal device (22) has access to an internal contacts folder (24) containing contacts data. The software program (18) includes a consolidator (60), which handles accumulation of contacts data input from one or more data sources (20). It also includes a virtual contact repository (38) which accepts the contacts data input from the consolidator (60) to produce a set of updated contacts data (68), and a replicator (70) which takes in the set of updated contacts data (68) from the virtual contacts repository (38), and periodically pushes the updated contacts data (68) to the internal contacts folders (24), which are accessible by the personal devices (22).

### TECHNICAL FIELD

The present invention relates generally to software for Personal Digital Assistants (PDAs), handheld computers and wireless handsets.

### BACKGROUND ART

Effective communications is a crucial element in the day-to-day activities of all organizations. The popularity of BlackBerry and other wireless handhelds has had a dramatic and positive impact on the ability to communicate both by email and phone. While technology has progressed, the management of contact information has lagged—critical information can quickly become out of date on a user-by-user basis.

As an example, Microsoft Outlook has an excellent Personal Information Manager (PIM). When Outlook is connected to an Exchange Server, address information for all members of the organization is generally available from the Global Address List (GAL). Because the GAL has high availability, the information it contains does not need to be added to a user's contact folder. Thus, a typical contact folder would contain personal information of friends, customers, vendors and contacts outside of the organization. With the advent of BlackBerry handhelds and PDA's, this has changed.

When trying to reach a co-worker in an urgent situation, a mobile user needs one or more of these key pieces of information:

PIN—A unique identifier for each BlackBerry handheld

Mobile Phone Number

Office Phone Number

Home Phone Number

Numeric Pager Number

Nextel Direct Connect “Radio Telephone Number”

This information can be added to the Outlook Contact Folder from either the handheld, or from Outlook itself. In either case, contact data becomes outdated as other members of the organization get new cell phones, upgrade BlackBerry handhelds, or move to alternate office locations. Not having critical information is compounded when organizations have hundreds, or even thousands of handhelds, and their respective users each have hundreds or thousands of contacts. To date, no solution has addressed maintenance of enterprise related information that resides in user contact folders. It is typically the responsibility of each user to ensure the accuracy and completeness of information in their personal contacts. With a collective sum of millions of contacts, it is an unfortunate reality that erroneous or incomplete contact data is synchronized between contacts and handhelds on a daily basis.

Although synchronization of data may be difficult during everyday operation of businesses, it is especially challenging during time of emergency. During the tragic events of September 11, many organizations lost Internet connectivity to their datacenter, or in a more catastrophic'scenario, their datacenter was a complete loss—E-Mail servers and BlackBerry Servers were destroyed. However, there are some instances where people with BlackBerry handhelds could still communicate with other members of their organization that also had a BlackBerry. They did this using a form of communication known as PIN to PIN communication. The PIN to PIN communication does not require an email server, or BlackBerry server. Messages are relayed through the wireless network and the BlackBerry SRP (Source Routing Protocol), and then directly to another handheld. The same capability is possible with SMS (Short Message Service) on cell phones. In many instances, a typical PIM (Personal Information Manager) may also have some obsolete emergency information such as home phone, cell phone and other emergency contact information.

The average individual has hundreds of personal contacts in their PIM that are actually referencing people within their own organization. In an actual emergency, it is inevitable that emergency contact information, such as BlackBerry PIN's, mobile phone numbers and home phone numbers will either be out of date, missing or wrong.

There have been several attempts at solving the problem of providing updated information to multiple PIMs. Synchronization solutions have been developed that allow individual users to synchronize their PIM information with handhelds and sometimes with an Internet service that possibly contains other contact information that a user may desire to add to their address book. To date, other solutions have focused on routinely providing user access to PIM information via databases housed in a datacenter. When organizations define their Emergency Preparedness plans, these servers are presumed to be a total loss. The most common devices available after such a scenario will be laptops, BlackBerry handhelds, PDA's and mobile phones that will be heavily used although little has been done to maximize the effectiveness of these devices in catastrophic situations.

There are Internet based solutions that could partially solve this same problem. This existing synchronization allows individual users to synchronize their PIM information with an Internet service that possibly contains other contact information that a user may desire to add to their address book. This information comes from other subscribers of the same Internet service that personally update their own contact information. However, this is not a viable “Enterprise” solution as thousands of subscribers would be required to sign up for and make their personal information available on a pseudo public database.

Other solutions to this problem have attempted to build a standalone application and database. This may require that special software be installed on a handheld computer, or that a Web Browser that is used to access emergency contact information which greatly decreases availability during emergencies.

A large organization that has hundreds or possibly thousands of users can publish emergency contact information on their intranet or other internal directories. After a catastrophe, and if a user has synchronized their handheld PIM recently, there is still no guarantee that a user would have access to use these forms of communication:

call a colleagues cell phone;

call a colleagues home phone;

send a colleagues an SMS (short message system);

send a colleague a BlackBerry PIN to PIN message;

use a Nextel Direct connect option to contact a colleague;

use an alternate, non corporate email internet SMTP address to contact a colleague; or

send a fax to a colleague.

During, or just after a catastrophic event, it is improbable that everyone will have access to the company intranet (if it in fact still exists.)

Thus there is a need for a system that allows automatic updating and mandatory dissemination of information of contact information for mobile users which is updated on a regular basis, so that information is more current, which does not require surrendering personal data to a pseudo public database, and provides a reliable base of Enterprise organizational information.

### DISCLOSURE OF INVENTION

Accordingly, it is an object of the present invention to provide a system that improves availability of emergency information before, during and after an emergency for PIM applications by updating information on a regularly scheduled basis.

Another object of the invention is to provide a system which provides a reliable base of Enterprise information which is available to members of the Enterprise, and which is held behind the firewall of the Enterprise.

And another object of the invention is to provide a system that pushes information to the contacts folders of each user periodically which makes the information less vulnerable to damage.

A further object of the present invention is to provide mobile users a consistent and simple method to report their location and well being to their manager or emergency contact coordinator. This information will be tabulated on one or more designated mobile computers as to avoid dependencies on any single piece of network infrastructure.

An additional object of the present invention is to allow PIM contact information from individuals outside of an organization to also be automatically updated and dissemenated.

Yet another object of the present invention is to add specific PIM contact information to mobile handhelds. For example, users may not add the contact information for a help desk, Police, Fire, medical, onsite security to their PIM. The ACRS administrator could mandate such information that could conceivably save a life or avert a crime.

A further object is to clear information that is erroneous from contacts folders of personal devices.

Briefly, one preferred embodiment of the present invention is a software program for periodically collecting and distributing updated information to a number of personal devices, to be used with a central server having a database, a data network including at least one server, where each personal device having access to an internal contacts folder containing contacts data. The software program includes a consolidator, which handles accumulation of contacts data input from one or more data sources. It also includes a virtual contact repository which accepts the contacts data input from the consolidator to produce a set of updated contacts data, and a replicator which takes in the set of updated contacts data from the virtual contacts repository, and periodically pushes the updated contacts data to the internal contacts folders, which are accessible by the personal devices.

Also disclosed are a system and a method for using the system.

An advantage of the present invention is that information may be more available to PIM devices after an emergency if central datacenters are disabled.

Another advantage of the present invention is that personal information is kept within the confines of a company's firewall rather than being collected by an inter-company database, which may prompt privacy concerns.

And another advantage of the present invention is that users will have more current information even in non-emergency circumstances thereby increasing daily productivity with efficient contact capabilities.

And another advantage is that personal information which must be unique across the organiztion will be cleared from outdated contacts.

A further advantage of the present invention is that by having information distributed to PDAs, data is less centralized, and less vulnerable to damage than data that is held in a single central location.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1A shows a schematic view of an Automated Contacts Replication System (ACRS) used in the acquisition and consolidation of contact information from a number of data sources;

FIG. 1B shows a detail view of data which is stored on a data source;

FIG. 2 shows a schematic view of an Automated Contacts Replication System (ACRS) used in the replicating of contact information to individual Personal Information Managers (PIMs);

FIG. 3 shows a block diagram of the consolidation process for transfer of data from a number of data sources to a Virtual Contacts Repository; and

FIG. 4 shows a block diagram of the consolidation and replication process for transfer of data from a number of data sources to a consolidator, to a Virtual Contacts Repository and through a replicator back to the Network; and

FIG. 5 shows a flow chart of the steps involved in replicating data into a personal devices' contacts folder.

### BEST MODE FOR CARRYING OUT THE INVENTION

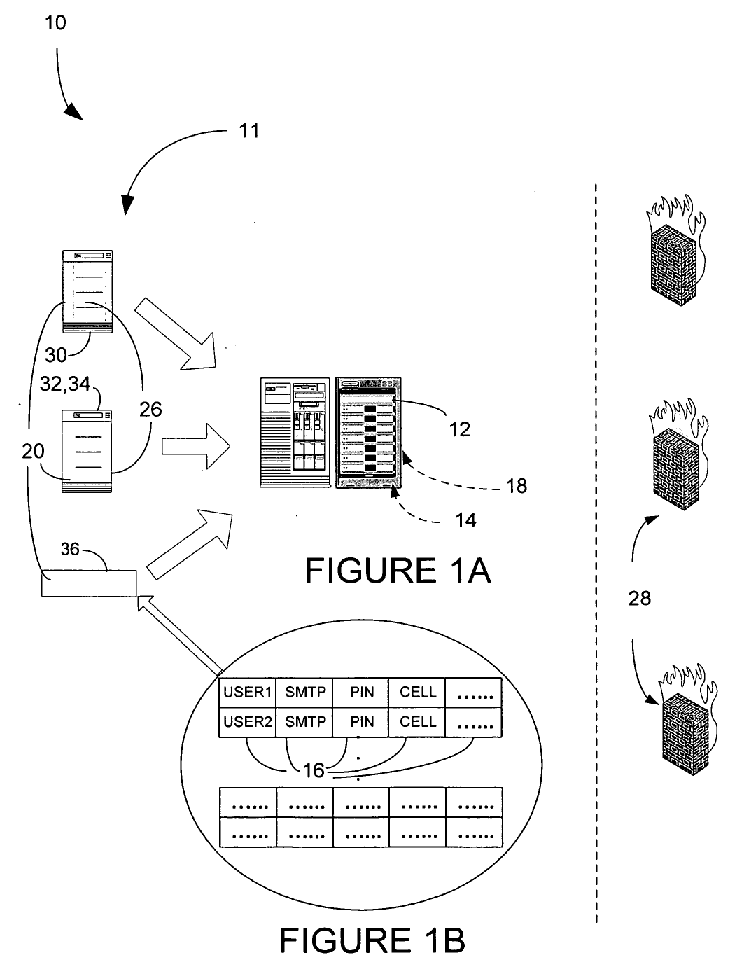

A preferred embodiment of the present invention is an Automated Contacts Replication System (ACRS) 10. As illustrated in the various drawings herein, and particularly in the view of FIG. 1A, a form of this preferred embodiment of the inventive device is depicted by the general reference character 10.

FIGS. 1A-B and 2 show schematic views of an Automated Contacts Replication System (ACRS) 10, which is used in the acquisition and management of contact information. Each night, or on some other administratively scheduled interval, information is gathered from data sources 20 through a network 11, which can be a wireless network or a wired network. These include servers 26 such as BlackBerry 30 or other wireless servers, LDAP 32, Global Address Lists 34 on e-mail servers, pre-existing enterprise wide directories and databases 36,. This information is input to a central server 12, containing a database 14 having data entries and the ACRS software program 18. All activity on the system occurs behind the firewall 28 of the enterprise.

Information from BlackBerry Servers 30, such as a PIN that is matched to information in the database 14, is compared, and if there are discrepancies, data entries 16 (see FIG. 1B) in the database 14 are updated.

The term central server 12 will be used for the physical device which includes and runs the ACRS software program 18. Although it is shown separately from the servers 26 which are providing input to the central server 12, it is also possible that the central server 12 is one or more of the company servers on which information, such as the company database 36 is located. The central server 12 may also be one or more servers, and is not to be construed as being limited to a single server.

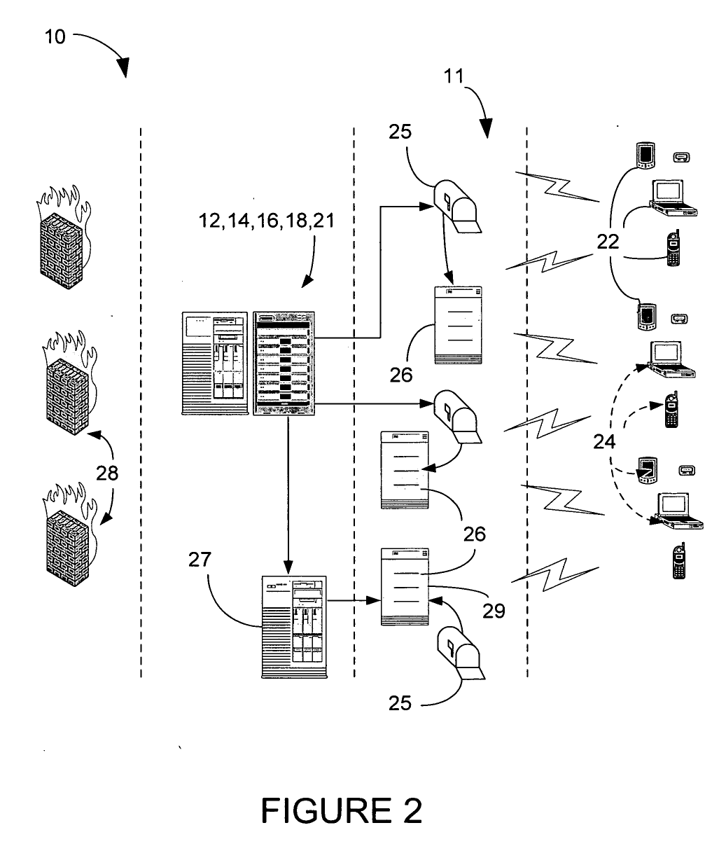

FIG. 2 shows a schematic view of the ACRS 10 used in the replicating of contact information to individual personal devices 22 such as Personal Information Managers (PIMs), Personal Data Assistants (PDAs), personal computers and laptops. Each device has its own address book or contacts list, which contain names, addresses, phone numbers, and e-mail addresses, and most importantly, up to date PIN numbers. These will be referred to collectively as the device' internal contacts folders 24. These are generally held on servers 26 to which the personal devices 22 have access.

The central server 12 may also be in communication with one or more satellite servers 27, which may service other servers 29 that are in locations which are geographically separate from the central server 12. For example, there may be one or more servers 26 in the Washington area, and other servers 29 in California. In order to maximize efficiency, the central server 12 may use the satellite server 27 to replicate information to the California servers 29, while the Washington servers 26 are serviced by the central server 12. The central server 12 includes a geographical replication filter 21 which determines whether one of the satellite servers 27 or the central server 12 will provide replication.

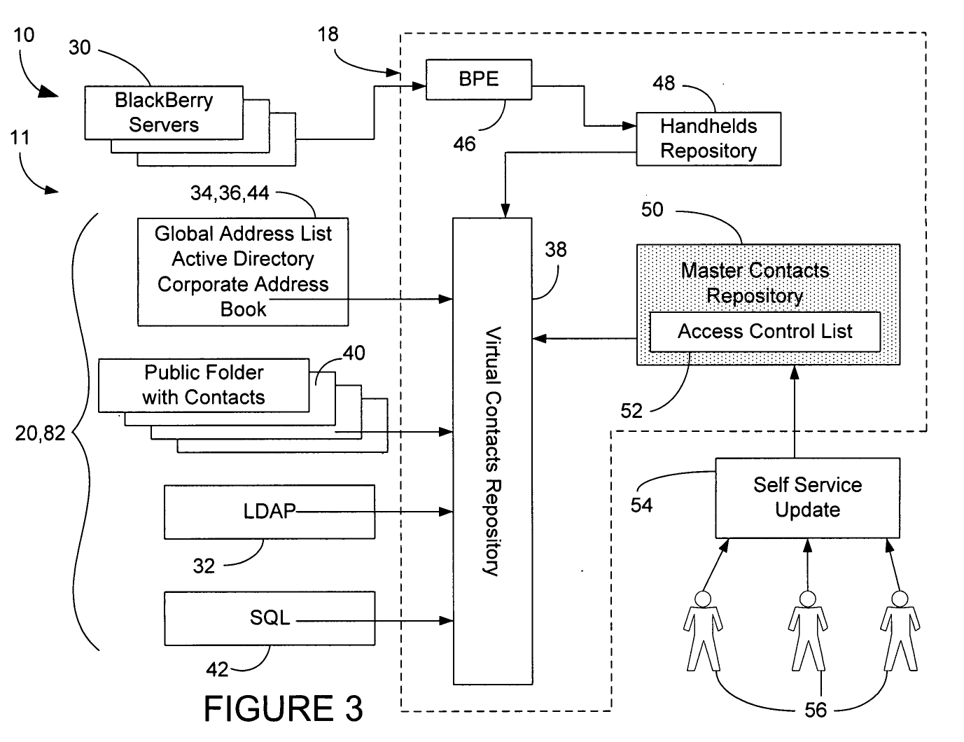

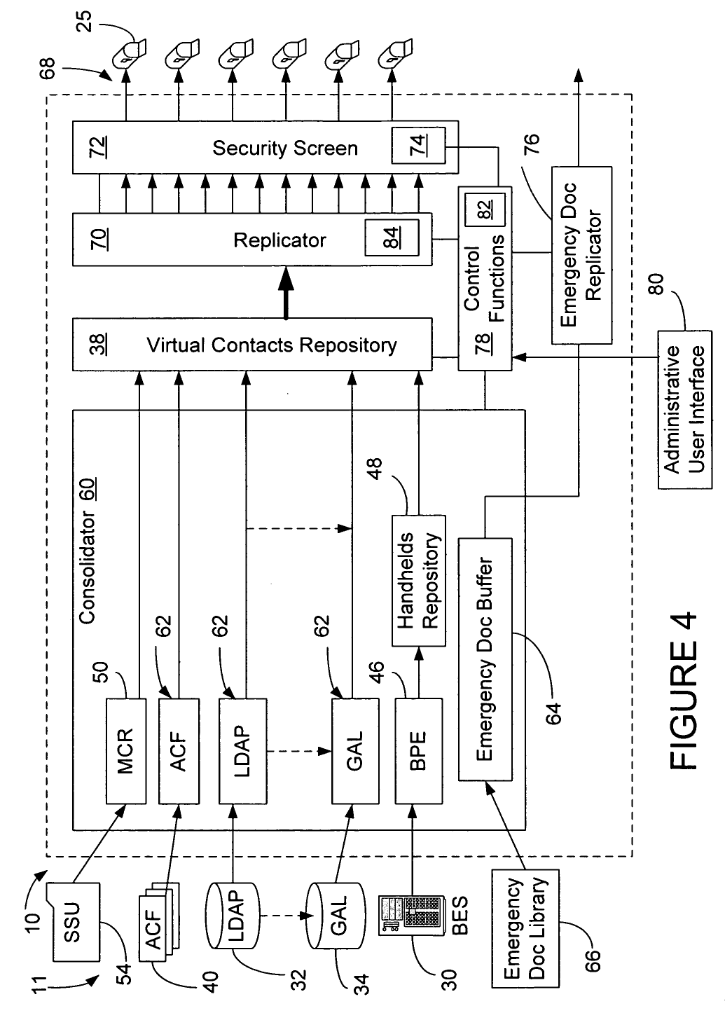

FIGS. 3 and 4 show block diagrams of the functional blocks included in the ACRS program 18, as well as their interaction with various device and folders on network devices 11. These network devices 11 provide input to a Virtual Contact Repository (VCR) 38 which is part of the ACRS software 18. The VCR 38 is generated “on the fly” from information collected from network 11 devices at scheduled intervals. In the figure, the VCR 38 is shown accepting input from an Lightweight Directory Access Protocol (LDAP) 32, from a number of public folders, referred to here as Alternate Contacts Folders (ACF) 40 with contacts on the e-mail system, from other commercial databases such as SQL, Oracle and Microsoft 42, and from company databases 36, which include Global Address Lists 34, and Corporate Address Books 44. A number of BlackBerry Servers 30 are shown communicating with a BlackBerry PIN Extraction (BPE) 46 which is included in the ACRS software 18. Information such as PINs from the BPE 46 is stored in a Handhelds Repository 48. Information gathered is collected in the VCM 38, and periodically pushed out to the personal devices 22 or servers 26 containing mailboxes 25 for the personal devices 26, as will be described below.

Also included in the ACRS software 18 structure is a Master Contacts Repository (MCR) 50 which contacts contact information such as home phone numbers, and other information which is not in the GAL. The MCR 50 also includes an Access Control List (ACL) 52 of who is allowed to access such data as home phone numbers, etc., so that for instance, a CEO's vacation home address is only available to those who have been approved for such information. Entries in the MCR 50 are obtained by executing a Self Service Update (SSU) 54 routine. This SSU 54 involves soliciting input from users 56 periodically to establish the most current data, as will be discussed below.

As seen particularly in FIG. 4, the functions of the ACRS software 18 can be considered as being included in larger functional groups. The consolidator 60 is a functional block concerned with accumulating incoming data from the network 11. It includes a number of connectors 62, which are configured to interface with the various external servers 26 or commercial database structure 42. These connectors 62 include any software or communication protocols necessary to interface with, for example, LDAP 32, and GAL 34. The number and type of connectors 62 is flexible and variable to include large numbers and types of external structures, as indicated by the dashed lines. BPE 46 is included which connects to external BlackBerry Servers 30, and routes data to a Handhelds Repository 48, as discussed above. An Emergency Documents connector 64 accesses an Emergency Documents Library 66, which may have a number of emergency procedure bulletins which can be pushed to the personal devices if triggered by emergency events. As discussed above, a Master Contacts Repository (MCR) 50 gets input from Self Service Updates (SSU) 54.

The consolidator 60 takes the accumulated data and forms the Virtual Contact Repository (VCR) 38 “on the fly” as discussed above. This accumulated updated information 68 is then passed to another major functional block, the Replicator 70, which pushes the data back out to the network 11 at periodically scheduled intervals. Before the data is sent out, however, it is vetted or filtered through a Security Screen 72 containing distribution criteria 74 or permission lists. Certain information, such as the CEOs home phone number, may be distributed only to selective personnel. The Security Screen 72 makes sure that some of the data is selectively routed according to the distribution criteria 74.

It should be noted that ACRS does not synchronize data which attempts to reconcile differences from two different data sources which may have both changed the same data prior to synchronization. In a synchronization strategy, both sources are assumed to be of equal worth and typically some complex set of rules resolves conflicts. ACRS is designed to disseminate data from trusted sources and push the data from Primary sources to secondary consumers.

Emergency documents are pushed by the Emergency Document Pusher 76, which is a replicator of its own.

There is a module of Control Functions 78, which controls, among other things, the frequency of consolidating and replicating data, the distribution criteria, creation of new connectors, issuance of emergency documents, etc. An Administrative User Interface 80 allows the system administrator to set the control functions 78.

When collecting data from the various sources of the network 11, a search path 82 or series of priorities are established as to how trusted the information is. So, for example, the search path 82 may be established so that first the SQL database 42 is searched, then the LDAP 32, next the Public Folders 40, and finally the GAL 34 of the enterprise. The effect of this is to establish an order of trust for the data encountered, with the level of trust decreasing along the search path from first to last. So, again for example, if a cell phone number is found in the SQL database 42, which is searched first, and later a conflicting cell phone number is found in the GAL 34, the SQL data will be most trusted and used instead of the GAL data. If non-contradictory data is found in different sources, then it is all consolidated in the VCR 38, as described above.

The Master Contacts Repository 50 has been defined to have the highest trust, as it is information that is gathered directly from queries to the users 56 through the Self Service Update 68. An exception to this is a BlackBerry PIN which was derived from an automated process and is always presumed to be the most accurate information available. ACRS Self Service Contact Updates will allow individual users to update their own personal contact information. This information will be stored in the MCR where ACRS PIM updates can be used to push the updated contact information throughout the organization. This updated contact information could also be used to update the Global Address List or Active Directory.

As part of the Self Service Update 68 routine, a Self Service Update Request will be sent preferably as an e-mail form. The form will be sent to all recipients on a Self Service Membership list on a periodic interval, generally defaulting to 60 days from the last record of a recipient acknowledgment and may be adjusted by the Administrator. When e-mail is not available an HTML web page will display the form.

The Self Service Update Request form will contain a message with instructions on how to update personal contact information. The form will include edit boxes for crucial contact information. A representative form would include:

Required Information:

Home Phone

Mobile Phone

Office Phone Number

Optional Information:

Pager

Fax

Nextel Direct Connect ID (only appears if user is iDEN—possible have special form)

Secondary E-Mail address

An additional property sheet may be customized to request this Information:

Main office Phone number

Title

Address

City, State

Postal Code

Country

Department

Assistants E-Mail address (via GAL Selection)

Assistants Phone Number

When information is either updated or confirmed as being accurate, a notation of completion for that particular user is made in the MCR 50, and the user is not contacted for updates until the next scheduled round of queries, perhaps 60 days later. This is configurable by the Administrator. If notation of completion is not made, the user can be queried again until a complete response is noted.

Certain information will be treated as mandatory for receipt by all employees in defined target groups, which may be as large as the entire company or enterprise or as small as a work crew. A Mandatory Contact Lists (MCL) 84 is included in the Replicator 70 module. The Mandatory Contacts List 84 ensures that contacts from a Mandatory Contact Source are always pushed to users specified as Mandatory Contact Targets even if the specified users do not specifically add that contact themselves. This feature pertains to special records such as “campus security”, fire, and police. The MCL 84 allows pushing contacts to a user folder even if this contact doesn't already exist. An example of a Mandatory Contact Source is “Emergency Response Team”. An example of a Mandatory Contact Target is “All HQ Staff”. The Campus Security contact would be placed in the mailbox of everyone at HQ.

Criteria for the MCL contacts and target groups are set by the system administrator. The list will focus around groups of contacts that are designated as “Required”. For example, IT Emergency Contacts has the contact people for on call Firewall administrator, Telecom manager, and email administrator. Each Mandatory Contact List (MCL) will be a row in the container. Although the specifics of the row contents may vary, a preferred embodiment will show:

A Friendly Name

Source—A truncated list of display names of Distribution Lists and Recipients that are being pushed. To see the full list, one must double click on the respective row.

Source count—Total number of contacts that are in the MCL that are being pushed.

Destination—The truncated list of users that will be required to store the Mandatory Contacts in their contacts folder. To see the full list, one must double click on the respective row.

Destination Count—The total number of users that will be required to store the Mandatory Contacts in their contacts folder, as the ACRS may not have permissions or be configured to write to the mailboxes for all of these users.

When an administrator double clicks on a row for an MCL, list boxes will enumerate the source and destination lists. An option to drill down into the destination recipients that enumerate fully expanded DL's showing which users are enabled for updates after geographic replication filters 21 are applied.

A user must be enabled for ACRS, or in an ACRS license pack, to receive Mandatory Contact Updates, and Mandatory Contacts which are automatically removed if users are removed from the MCL or any distribution list in the MCL target list.

An ACRS footprint is left on every contact written by ACRS to a user's folder so that Mandatory Contacts in these folders could be manually purged without effecting users personal data. An Outlook View could be used to see exactly ACRS created contacts and allow someone to manually delete them. If a user already has a contact that is in an MCL, it will be updated and not have the footprint.

An administrator may desire to remove certain contacts on a system wide basis. A Forced Deletion List (FDL) (not shown) is a sub container under the ACRS main container. If there is a conflict between and MCL and an FDL, the Mandatory Contact will always win. A warning will be sent to the administrator that the FDL is ignored.

Also categorized as most trusted is information from the BlackBerry Servers (BES) 30 concerning the PIN information, which is then collected in the Handhelds Repository 48. An optional parameter (a checkbox) on any MCL can also make it a PIN Distribution List. If a handheld is configured to send PIN DL's, it will receive an x-RimDeviceitrezzoPIN.DL attachment when the Automated Contact update is sent. The format will be in XML and will contain: MCL Friendly Name, than User Display Name, PIN for each DL member that has a BlackBerry.

Alternate Contact Folders (ACF's) 40 will serve two purposes: First as a user definable list for Mandatory Contacts to be pushed to users. Second, ACF's will be used to define contacts independent of the GAL and Handhelds folder as a source of information that will be utilized to update user contacts. The typical use for an alternate contact folder may be for a department or workgroup to share a preexisting contact folder. It may have internal or external contacts.

Referring now also to FIG. 2, each night, or on some other administratively scheduled interval, the central server 12 transfers the updated contact information 68 from its database 14 to local servers 26, which again include local BES 30, LDAP 32 and the e-mail GAL 34.

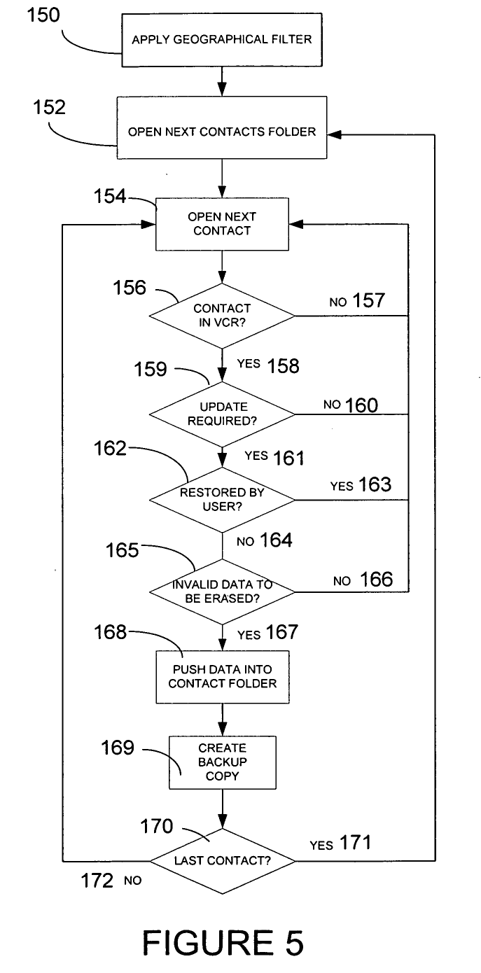

FIG. 5 shows a flow chart of the steps involved in the replication process. The geographical filter, discussed above is first applied 150, so that the correct satellite server is used for the current geographical area. Then, starting with the first personal device user configured for Emergency PIM service, a user is selected and checked by its email address to see if that user is in the VCR 156. If the user is not in the VCR, the user is skipped to the next user 154.

Once a user is identified as being included in the database, the user's internal Contacts Folder is opened 152. The first contact is opened 154 and checked to see if it is in the database 156. If the answer is “No” 157, the next contact is opened 154.

If the answer is “yes” 158, the information in the contact is compared with that in the Virtual Contacts Repository. The info is checked to see if it requires updating 159. If the answer is “no” 160, the next contact is opened 154. If yes, a check is made to see if it has been restored by the user 162. If yes 163, the next contact is opened 154. If no 164, another check is made whether the invalid data is to be erased 165. If no 166, the next contact is opened 154. If yes 167, contact information is then pushed into the Contact Folder 168. This contact information may be anything the administrator chooses to push. Typically (but not limited to these fields) the following fields would be updated automatically: cell phone number, home phone number, SMS Address, BlackBerry PIN, Nextel Direct Connect address, an alternate, non corporate email internet SMTP address, and/or a fax number. Only the fields that have been determined to require update will be changed. All other existing user contact fields will remain unchanged.

Then a backup copy is created 169 in a backup folder. The file is checked to see if it is the last contact 170. If no 171, the next contact is opened 154. If yes 172, then the next contacts folder is opened 152. Although not shown, a query is made as to whether the contacts folder is the last, and if so the replication ends. If not, it continues.

The updated information 68 may be automatically pushed into the folder, or alternately, the personal device user's existing information may be compared with the information in the VCR 38. If the existing information is already correct, the system may skip to the next contact 180. All the contacts in a user's contact folder may then be operated upon until the last contact is completed. The system then selects the next user and the routine is repeated for all entries in that user's contact folder. All contacts modified by ACRS are automatically backed up to a Backup folder that is immediately below the users contact folder. In the event that ACRS does overwrite some important information, it will be a trivial task for a technician to recover contacts that a user may need. If necessary, a helpdesk staff member can describe the restoration process to the user. If a contact changes several times, each version of the changed contact will be aged. Any backup contact older than 30 days is purged. The Backup folder can be deleted at any time and will automatically be recreated each time ACRS changes a user contact.

In most cases, users will cradle their handheld and update their handheld PIM using synchronization software once each day. After the Automated Contacts Replication System (ACRS) 10 is installed and run the first time, users will notice that their contacts will receive many changes. Subsequent executions will yield negligible updates.

Another positive side effect is that even in non-emergency circumstances, handheld users will enjoy having highly accurate and up to date information in their PIM. This would previously have taken an intense amount of manual labor to keep their PIM up do date.

Enterprises create and maintain a “phone book” that is published periodically. The Phone books sometimes contain a wide variety of PIM data. All of the solutions built to date focus on retrieving this information under normal circumstances. There is usually only a business case for this information “In an emergency”. There are providers of handheld PIM synchronization software and there are providers of enterprise wide directory databases and software. Building an automated solution that guarantees up to date PIM information is not the responsibility of either of these two entities.

To date, other solutions have focused on routinely providing user access to PIM information via databases housed in a datacenter. When organizations define their Emergency Preparedness plans, these servers are presumed to be a total loss. Pushing information to the PIM folders on Enterprise email servers will radically improve the availability of emergency contact information before, during and after an emergency.

Synchronization solutions have been developed that allow individual users to synchronize their PIM information with handhelds and sometimes with an Internet service that possibly contains other contact information that a user may desire to add to their address book. This information comes from other subscribers of the same Internet service that personally update their own contact information. The other Internet based solution will not provide a reliable base of Enterprise organizational information, as thousands of subscribers would be required to sign up for and make their personal information available on a pseudo public database.

By contrast, the present Automated Contacts Replication System (ACRS) 10 is more complimentary to this service as it focuses on the Enterprise where the other services focus on inter enterprise solutions.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

### Industrial Applicability

The Automated Contacts Replication System (ACRS) 10 is well suited generally for maintaining updated contacts information for use in any number of commercial enterprises and corporate business organizations.

Communications in modern corporations and enterprises is very crucial, and the ability to contact a key person accurately and efficiently is very important. The popularity of BlackBerry and other wireless handhelds has had a dramatic and positive impact on the ability to communicate both by email and phone. The management of contact information is thus very important to an efficient business operation. Contact data becomes out dated as other members of the organization get new cell phones, upgrade BlackBerry handhelds, or move to alternate office locations. Not having critical information is compounded when organizations have hundreds, or even thousands of handhelds, and their respective users each have hundreds or thousands of contacts. To date, no solution has addressed maintenance of enterprise related information that resides in user contact folders. It is typically the responsibility of each user to ensure the accuracy and completeness of information in their personal contacts. With a collective sum of millions of contacts, it is an unfortunate reality that erroneous contact data is synchronized between contacts and handhelds on a daily basis.

Although replication of data may be difficult during everyday operation of businesses, it is especially challenging during time of emergency. During the tragic events of September 11, many organizations lost Internet connectivity to their datacenter, or in a more catastrophic scenario, their datacenter was a complete loss—E-Mail servers and BlackBerry Servers were destroyed. However, there are some instances where people with BlackBerry handhelds could still communicate with other members of their organization that also had a BlackBerry. They did this using a form of communication known as PIN to PIN communication. The PIN to PIN communication does not require an email server, or BlackBerry server. Messages are relayed through the wireless network and the BlackBerry SRP (Source Routing Protocol), and then directly to another handheld. The same capability is possible with SMS (Short Message Service) on cell phones. In many instances, a typical PIM (Personal Information Manager) may also have some obsolete emergency information such as home phone, cell phone and other emergency contact information.

The average individual has hundreds of personal contacts in their PIM that are actually referencing people within their own organization. In an actual emergency, it is inevitable that emergency contact information, such as BlackBerry PIN's, mobile phone numbers and home phone numbers will either be out of date, missing or wrong. Thus a system that provides automated updates of contact information will have great industrial utility.

The Automated Contacts Replication System (ACRS) 10 collects data from a number of data sources 20. These data sources 20 provide input to a Virtual Contact Repository (VCR) 38 which is part of the ACRS software 18. The VCR 38 is generated “on the fly” from information collected from the data sources 20 at scheduled intervals. The data sources 20 can include input from an Lightweight Directory Access Protocol (LDAP) 32, from a number of public folders, referred to here as Alternate Contacts Folders (ACF) 40 with contacts on the e-mail system, from other commercial databases such as SQL, Oracle and Microsoft 42, and from company databases 36, which include Global Address Lists 34, and Corporate Address Books 44. A number of BlackBerry Servers 30 can communicate with a BlackBerry PIN Extraction (BPE) 46 which is included in the ACRS software 18. Information such as PINs from the BPE 46 is stored in a Handhelds Repository 48. Information gathered is collected in the VCM 38, and periodically pushed out to the personal devices 22 or servers 26 containing mailboxes 25 for the personal devices 26, as will be described below.

Also included in the ACRS software 18 structure is a Master Contacts Repository (MCR) 50 which contacts contact information such as home phone numbers, and other information which is not in the GAL. The MCR 50 also includes an Access Control List (ACL) 52 of who is allowed to access such data as home phone numbers, etc., Entries in the MCR 50 are obtained by executing a Self Service Update (SSU) 54 routine. This SSU 54 involves soliciting input from users 56 periodically to establish the most current data, as will be discussed below.

The functions of the ACRS software 18 include a consolidator 60 which is concerned with accumulating incoming data from the data sources 20. It includes a number of connectors 62, which are configured to interface with the various external servers 26 or commercial database structure 42. These connectors 62 include any software or communication protocols necessary to interface with, for example, LDAP 32, and the mail system GAL 34. The number and type of connectors 62 is flexible and variable to include large numbers and types of external structures, as indicated by the dashed lines. A BPE 46 is included which connects to external BESs 30, and routes data to a Handhelds Repository 48, as discussed above. An Emergency Documents connector 64 accesses an Emergency Documents Library 66, which may have a number of emergency procedure bulletins which can be pushed to the personal devices if triggered by emergency events.

The consolidator 60 takes the accumulated data and forms the Virtual Contact Repository (VCR) 38 “on the fly” as discussed above. This accumulated updated information 68 is then passed to another major functional block, the Replicator 70, which pushes the data back out to the network 11 at periodically scheduled intervals. Before the data is sent out, however, it is vetted or filtered through a Security Screen 72 containing distribution criteria 74 or permission lists. Certain information, such as the CEOs home phone number, may be distributed only to selective personnel. The Security Screen 72 makes sure that some of the data is selectively routed according to the distribution criteria 74.

The Automated Contacts Replication System (ACRS) 10 thus provide automated updating of contact information which improves efficiency of enterprises and organizations in normal commercial settings and during times of emergency.

For the above, and other, reasons, it is expected that the Automated Contacts Replication System (ACRS) 10 of the present invention will have widespread industrial applicability. Therefore, it is expected that the commercial utility of the present invention will be extensive and long lasting.

What is claimed is:

1. A software program for periodically collecting and distributing updated information to a plurality of personal devices, to be used with a central server having a database, a data network including at least one server, and said plurality of personal devices, each said personal device having access to an internal contacts folder containing contacts data, said software program comprising:
a consolidator, which handles accumulation of contacts data input from one or more data sources;
a virtual contact repository which accepts said contacts data input from said consolidator to produce a set of updated contacts data;
a replicator which takes in said set of updated contacts data from said virtual contacts repository, and periodically pushes said updated contacts data to said internal contacts folders, which are accessible by said plurality of personal devices.

2. The software program of claim 1, wherein said consolidator accepts contacts data input from one or more data sources chosen from a group consisting of BlackBerry servers, GALs, LDAPs, alternate contacts folders, Active Directories, corporate address books and SQL.

3. The software program of claim 1, further comprising:
a master contacts repository.

4. The software program of claim 3, wherein said consolidator further accepts contacts data input from said master contacts repository.

5. The software program of claim 3, wherein said master contacts repository receives updated contacts data from a self service update routine.

6. The software program of claim 3, wherein:
said master contacts repository includes an access control list.

7. The software program of claim 1, wherein said consolidator further comprises:
a handhelds repository.

8. The software program of claim 7, wherein said consolidator further accepts contacts data input from said handhelds repository.

9. The software program of claim 8, wherein said handhelds repository receives updated contacts data from a BlackBerry PIN Extractor which receives data from at least one BlackBerry Server.

10. The software program of claim 1, wherein said replicator further comprises:
a mandatory contacts list.

11. The software program of claim 1, further comprising:
an emergency documents replicator, which accesses an emergency documents library and pushes emergency documents to folders accessible by said plurality of personal devices.

12. The software program of claim 1, further comprising:
control functions which control aspects of said software program.

13. The software program of claim 12, further comprising:
an administrative user interface which connects to said control functions and is used to set various parameters of said control functions.

14. The software program of claim 12, wherein:
said control functions include a search path by which levels of trust may be assigned to said data sources, said search path determining the order in which contacts data is entered into said virtual contacts repository.

15. The software program of claim 1, further comprising:
a security screen, by which updated contacts data is filtered so that certain updated contacts data is routed only to approved internal contacts folders according to distribution criteria.

16. The software program of claim 1, wherein said consolidator further comprises:
at least one mandatory contacts list.

17. The software program of claim 1, further comprising:
a geographical replication filter, by which replication can be performed from one or more satellite servers.

18. A system for consolidating data from a plurality of data sources and periodically replicating information to a plurality of personal devices, said system comprising:
a central server including an automatic contacts replication system software program;
a data network; and
a plurality of personal devices, each having access to an internal contacts folder, each of said personal devices being connected to said central server by said data network, wherein said automatic contacts replication system software program periodically consolidates contacts data from said plurality of data sources, and periodically replicates updated data to said internal contacts folders accessed by said plurality of personal devices.

19. The system of claim 18, wherein said software program comprises:
a consolidator, which handles accumulation of contacts data input from one or more data sources;
a virtual contact repository which accepts said contacts data input from said consolidator to produce a set of updated contacts data;
a replicator which takes in said set of updated contacts data from said virtual contacts repository, and periodically pushes said updated contacts data to said internal contacts folders, which are accessible by said plurality of personal devices.

20. The system of claim 19, wherein said consolidator accepts contacts data input from one or more data sources chosen from a group consisting of BlackBerry servers, GALs, LDAPs, alternate contacts folders, Active Directories, corporate address books, and SQL.

21. The system of claim 19, wherein said software program further comprises:
a master contacts repository and consolidator further accepts contacts data input from said master contacts repository.

22. The system of claim 21, wherein:
said master contacts repository includes an access control list.

23. The system of claim 19, wherein said software program further comprises:
a handhelds repository and said consolidator further accepts contacts data input from said handhelds repository.

24. The system of claim 23, wherein said handhelds repository receives updated contacts data from a BlackBerry PIN Extractor which receives data from at least one BlackBerry Server.

25. The system of claim 19, wherein said software program further comprises:
a mandatory contacts list.

26. The system of claim 18, wherein said software program further comprises:
an emergency documents replicator, which accesses an emergency documents library and pushes emergency documents to folders accessible by said plurality of personal devices.

27. The system of claim 18, wherein said software program further comprises:
a security screen, by which updated contacts data is filtered so that certain updated contacts data is routed only to approved internal contacts folders according to distribution criteria.

28. The system of claim 18, wherein said software program further comprises:
at least one mandatory contacts list.

29. The system of claim 18, further comprising:
one or more satellite servers; and
a geographical replication filter by which a satellite server is used to provide replication.

30. A method for periodically collecting and distributing updated information to a plurality of personal devices, to be used with a datacenter having database, a data network including a plurality of servers having a plurality of data storage locations, and said plurality of personal devices, each personal device having access to an internal contacts folder containing contacts data, said method comprising:
A) consolidating data from one or more data sources by using a consolidator;
B) creating a set of updated data in a virtual contacts repository; and
C) periodically replicating said updated data from said virtual contacts repository to said internal contacts folders accessible by said plurality of personal devices by using a replicator.

31. The method of claim 30, wherein said consolidator of A) accepts contacts data input from one or more data sources chosen from a group consisting of BlackBerry servers, GALs, LDAPs, alternate contacts folders, Active Directories, corporate address books and SQL.

32. The method of claim 30, wherein said consolidator of A) further accepts contacts data input from a master contacts repository.

33. The method of claim 32, wherein A) further comprises:
i) using a self service update routine to update said master contacts repository: and
ii) providing an access control list in said master contacts repository to control access to data.

34. The method of claim 30, wherein said consolidator of A) further accepts contacts data input from a handhelds repository and said handhelds repository receives updated contacts data from a BlackBerry PIN Extractor which receives data from at least one BlackBerry Server.

35. The method of claim 30, wherein said replicator of C) further comprises:
a mandatory contacts list.

36. The method of claim 30, wherein C) further comprises:
i) providing an emergency documents replicator, which accesses an emergency documents library; and
ii) pushing emergency documents to folders accessible by said plurality of personal devices.

37. The method of claim 30, wherein A) further comprises:
i) providing control functions which control aspects of said software program.

38. The method of claim 37, wherein A) further comprises:
ii) providing an administrative user interface which connects to said control functions; and
iii) using said administrative user interface to set various parameters of said control functions.

39. The method of claim 37, wherein A) further comprises:
ii) providing a search path included within said control functions by which levels of trust may be assigned to said data sources, said search path determining the order in which contacts data is entered into said virtual contacts repository.

40. The method of claim 30, wherein C) further comprises:
i) providing a security screen, by which updated contacts data is filtered so that certain updated contacts data is routed only to approved internal contacts folders according to distribution criteria.

41. The method of claim 30, wherein A) further comprises:
i) providing at least one mandatory contact list.

42. The method of claim 30, wherein:
C) includes comparing data from said set of updated data and existing contacts data in said internal contacts folders accessible by said plurality of personal devices, and overwriting said existing contacts data which is different from said data in said set of updated data.

43. The method of claim 42, wherein:
C) includes copying said existing contacts data into a backup folder, whenever existing contacts data is overwritten by updated data.

44. The method of claim 43, wherein:
C) creating said back-up folder in said internal contacts folders of said plurality of personal devices if they do not already exist.

45. The method of claim 30, wherein:
said updated data to be pushed from said database in C) is chosen from a group consisting of BlackBerry PIN, SMS Address, mobile phone number, office phone number, home phone number, numeric pager number, Nextel Direct Connect address, an alternate, non corporate email internet SMTP address, fax number, Mandatory Contact Digest, and emergency procedures.

46. The method of claim 30, wherein C) further comprises:
i) maintaining at least one mandatory contacts list, whereby designated data is pushed to an internal contacts folder accessible by a personal device even if corresponding contacts do not yet exist in said internal contacts folder.
